(19) United States
(12) Patent Application Publication
(10) Pub. No.: US 2007/0022323 A1
(43) Pub. Date: Jan. 25, 2007

(54) Product framework for manufacturing testing environment

(76) Inventors: Aik Koon Loh, Loveland, CO (US); Rex M. Shang, Fort Collins, CO (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/184,612

(22) Filed: Jul. 19, 2005

(51) Int. Cl. G06F 11/00

(52) U.S. Cl. 714/38

(57) ABSTRACT

A software framework for centralizing the management of test plans, test configurations, test sources, debug information for testing electrical devices in a manufacturing testing environment is presented. A three-tier software architecture is defined that allows one-time effort and segregation of tasks related to integration of hardware devices, development of multiple applications, and testing of multiple applications.

### BACKGROUND OF THE INVENTION

In a product manufacturing testing environment, automated test systems are used to test manufactured products to determine proper functionality and acceptability for shipping the manufactured products. Often, a given automated test systems manufacturer will offer several different types of test systems for application to testing different types of products or for performing different types of tests on the products. For example, a manufacturer of integrated circuit test systems may offer several different types of test systems including in-circuit testers, x-ray inspection systems, optical inspection systems, and others. For each type of test system, the manufacturer may offer different test system products. For example, in-circuit testers, which may be used to achieve both continuity and functional testing, may be offered in varying sizes providing varying probing capability (which determines the maximum size integrated circuit device that can be tested using the particular in-circuit test system product). Furthermore, for each type of test system, the manufacturer may offer different configurations, for example, a base in-circuit test system product may be offered with several different optional add-on modules such as automatic test generation capability, debug modules, developer software modules, etc.

It is important in terms of product recognition and brand building for product test system manufacturers to develop a common look and feel among their products and different product lines. Different test system products and product lines are typically developed and engineered by different groups specializing in different areas of technology, leading to fragmentation and duplication of engineering effort across the products. For example, a test system manufacturer that offers in-circuit testers and automated optical inspection testers will typically employ two different mutually exclusive teams of engineers to develop and test the systems. To further exacerbate the problem, each team typically is formed of sub-teams of engineers of different specialties, for example, tester hardware engineers, tester control software engineers, tester application software engineers, communication hardware engineers, graphical user interface (GUI) development engineers, etc. Furthermore, different teams and sub-teams often reside in different global locations. Communication between teams and sub-teams is therefore often difficult. All of these factors lead to problems in developing the common look and feel among products and product lines that is necessary in developing and maintaining brand recognition. These factors also result in duplication in engineering efforts, application development, and testing of the systems.

According, it would therefore be desirable to have a software framework which would reduce duplication of engineering, application development, and testing efforts, provide fast and easy integration of hardware and software into different products and product lines, and facilitate a common look and feel among products and product lines.

### SUMMARY OF THE INVENTION

The present invention is a robust and flexible software framework to support the development and maintenance of a product framework for a manufacturing testing environment. The software framework presented herein segregates the development of software tasks in a manufacturing testing environment to achieve maximum efficiency and reduction in engineering, development, and testing efforts, and assists in the management of test system software.

In accordance with the invention, a three-tier software architecture is defined that includes controller, application, and algorithm layers. At the controller layer is a controller platform which includes all software providing product independent functions such as tasks related to environment setup, active panels, common-look-and-feel graphical user interface and use models, hardware interfaces, communication capability (e.g., internet, interLAN, and inter-process communication), functionality supporting a multithreading environment, and all other common functionalities intended to be provided across all product systems. At the application layer is a product platform which includes all software providing product specific functions. At the algorithm layer is a computing platform which includes all software providing computationally intensive functions such as image processing and neural network classification analysis. All software functionality within the product framework is implemented according to this software framework which enforces segregation of tasks related to the different software layers. The software framework thereby facilitates single development efforts for common functionality, provides a common look and feel across test system products, allows ease of, and one-time, integration of hardware devices, application development, and application testing, and allows faster time to market of new products and product lines.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of an exemplary software architecture for implementing a software framework for a test system product framework;

FIG. 2 is a block diagram illustrating an exemplary three-tier software framework for a product framework in accordance with the invention;

FIG. 3 is a block diagram of an exemplary product framework;

FIG. 4 is a block diagram illustrating the major control functions of an exemplary central test information controller and corresponding knowledge base for a manufacturing environment;

FIG. 5 is a schematic block diagram of an automated test system;

FIG. 6 is a schematic diagram of a prior art measurement circuit;

FIG. 7 is a block diagram of the software product platform for the automated test system of FIG. 5;

FIG. 8 is a block diagram of an exemplary embodiment of an action knowledge database structure;

FIG. 9 is a structural diagram of an exemplary embodiment of a rule;

FIG. 10 is a block diagram illustrating an exemplary software framework for a product framework of an in-circuit tester in accordance with the invention; and

FIG. 11 is a flowchart illustrating an exemplary method for implementing software in a plurality of different products.

### DETAILED DESCRIPTION

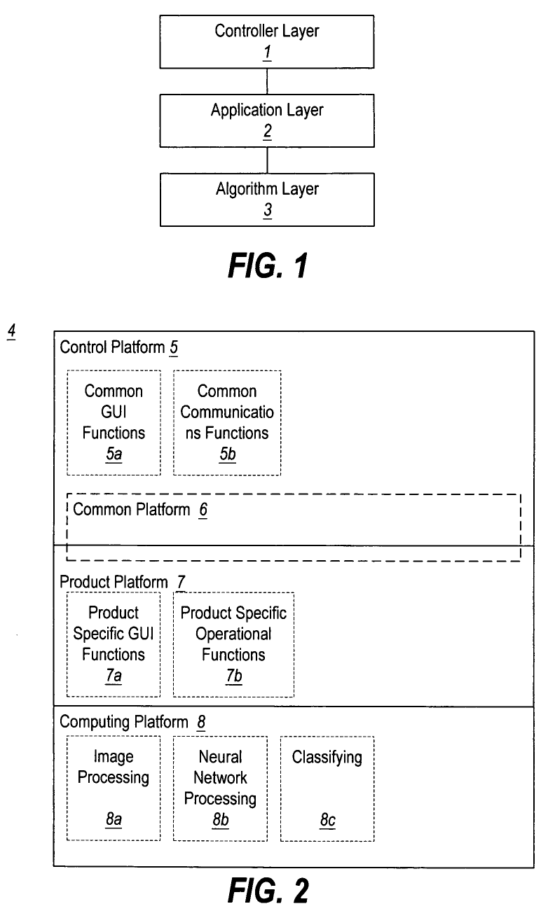

Turning now to the drawings, FIG. 1 illustrates a block diagram of an exemplary software architecture for implementing a software framework for a test system product framework. As illustrated therein, the software architecture applies a “layer” concept to the implementation of any software developed for the software framework of a product framework. In the preferred embodiment, the software architecture defines a controller layer 1, an application layer 2, and an algorithm layer 3. A software framework solution for a product framework can be achieved by applying the formal software structure of FIG. 1 to an exemplary three-tier software framework 4 as shown in FIG. 2. In this regard, the software framework 4 includes a control platform 5, a product platform 7, and a computing platform 8. The control platform 4 includes all software providing product independent functions such as common GUI routines 5a, communication routines 5b (e.g., internet, interLAN, and inter-process communication), tasks related to environment setup, active panels, common-look-and-feel graphical user interface and use models, hardware interfaces, functionality supporting a multithreading environment, and all other common functionalities intended to be provided across all product systems. The product platform 7 implements all software providing product specific functions such as product specific GUI routines 7a and product specific operational routines 7b. The computing platform 8 implements all software providing computationally intensive functionality such as image processing 8a, and/or neural network processing 8b, and classification analysis 8c.

Applying the software framework 4 to the software architecture of FIG. 1, it is shown that the control platform 4 is implemented at the controller layer 1, the product platform 7 is implemented at the application layer, and the computing platform 8 is implemented at the algorithm layer 3. All software functionality within the product framework is implemented according to this software framework which enforces segregation of tasks related to different software layers.

In addition, there may optionally be a common platform 6 which provides overlapping functionality between the control platform 5 and product platform 7.

Enforcing the software architecture layers, namely the controller layer 1, application layer 2, and algorithm layer 3, requires strict interface definitions between layers. By enforcing this architecture, the common functionality and common-look-and-feel aspects of all of the products can be segregated from the product specific functionality and computationally intensive algorithmic functionality of the products to allow single development effort of the control platform 5. The control platform 5 can therefore be developed once and reused across all products and product lines. The product platform 7 is by definition different for each product, and the computing platform 8 may also vary from product to product. However, since the interface between the product platform 7 and computing platform 8 is strictly defined to enforce the software architecture of FIG. 1, tasks for each layer are easily separable and integratable with the other platforms.

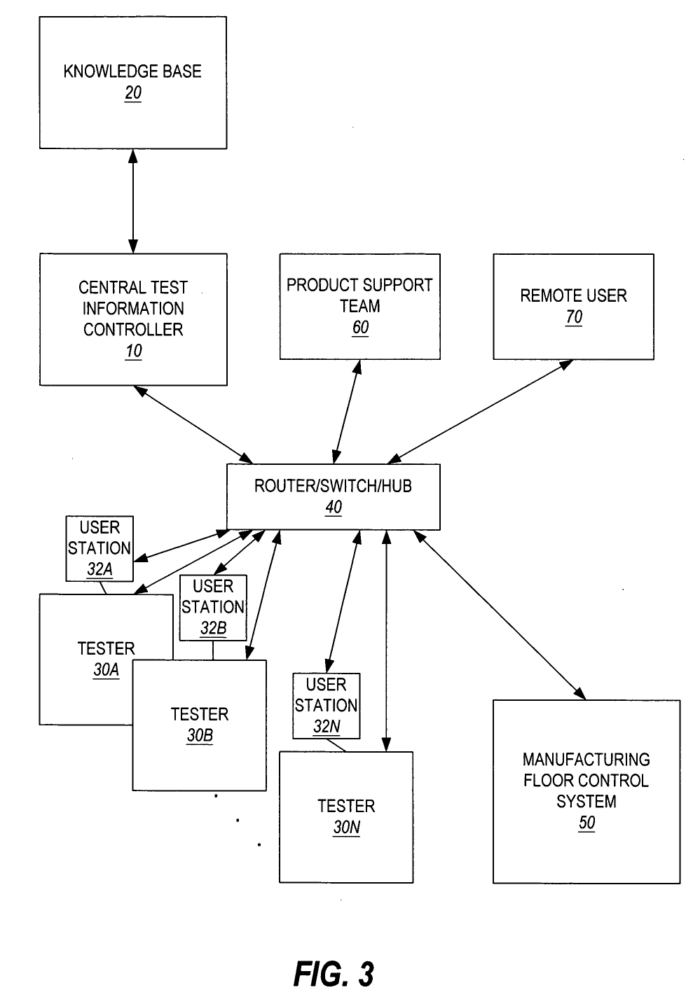

The software framework 4 of the invention will be better understood in the context of a product framework for a manufacturing test environment, and discussion will now turn thereto. FIG. 3 illustrates a block diagram of a product framework in accordance with the preferred embodiment of the invention. As illustrated therein, the product framework includes a central test information controller 10 which may provide control of and access to a knowledge base 20 that may include one or more of: assembly design test plans and test source configurations, a knowledge database, a localization database, test data history, analysis and optimization knowledge. The central test information controller 10 operates as an interface between the knowledge base 20 and one or more of: one or more test systems 30A, 30B, . . . , 30N, a manufacturing floor control system 50, and remote users 70 of the knowledge base such as test engineers, members of a product support team 60, and customers with controlled access.

The central test information controller 10 includes a control function, preferably in the form of a computer system comprising computer hardware that executes computer software which implements the control functionality described hereinafter. In the preferred embodiment, the computer system which implements the control function is implemented as an independent system remote from the actual test systems 30A, 30B, . . . , 30N and test system user stations 32A, 32B, . . . , 32N; however, it will be appreciated by those skilled in the art that the control function of the central test information controller 10 can be integrated into one or more of the test systems 30A, 30B, . . . , 30N and/or user stations 32A, 32B, . . . , 32N. If more than one potential control function (e.g., 21, 22, 23, and 24) is implemented throughout the test systems 30A, 30B, . . . , 30N and/or user stations 32A, 32B, . . . , 32N, the functionality of the control function may be distributed across the various control functions and/or the multiple potential control functions may arbitrate to determine and defer to a single one of the multiple potential control functions during operation of the central test information controller 10.

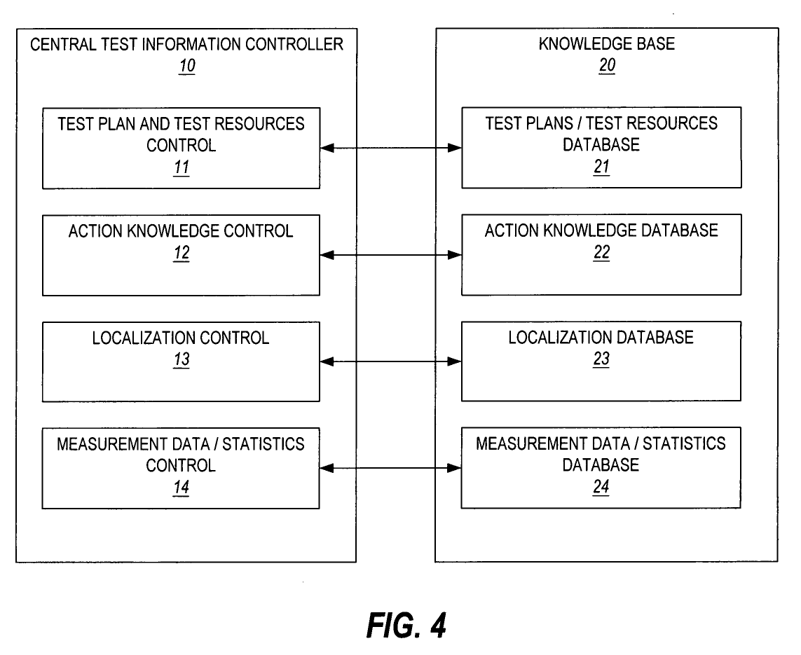

In the preferred embodiment, the central test information controller 10 centralizes and controls knowledge that may be used by any and all testers and various users. In the preferred embodiment, the central test information controller 10 controls knowledge relating to: (1) Test plans and corresponding Test Source configurations; (2) Action Knowledge relating to testing of particular components; (3) Localization Knowledge such as local translations of graphical user interface pages according to the language and presentation customs of a given locality; and (4) Historic Data and/or Statistics. FIG. 4 is a block diagram illustrating the major control functions of the central test information controller 10 and corresponding databases that collectively form the Knowledge Base 20. In the preferred embodiment, the central test information controller 10 may include a test plan and test resources control function 11 which reads and writes test plan and test resource information to a test plans and test resource database 21, an action knowledge control function 12 which reads and writes action knowledge relating to specific components of an assembly under test to an action knowledge database 22, a localization control function 13 which reads and writes localization information to a localization database 23, and a measurement data and statistics control function 14 which reads and writes measurement data and/or statistical information to a measurement data and statistics database 24.

During production manufacturing, test plans are followed that comprising suites of tests to be executed by the testers that test various components on the assembly under test. For example, when the assembly under test is a printed circuit board with components including resistors, capacitors, integrated circuits, and other discrete components, a test plan may include a series of tests for an in-circuit tester that includes tests that test each of the resistors for connectivity and resistance values, tests that test each of the capacitors for connectivity and capacitance values, and tests that test each of the integrated circuits for connectivity and functionality. This test plan may be followed for testing each manufactured board of identical design. Test resource configurations are derived from the PCB layout of the assembly under test and test plans determine the running sequence and coverage. During high volume production there may be multiple testers testing assemblies of the same design. Thus, when multiple testers are used to test manufactured boards during production, the test plan must be deployed to each tester.

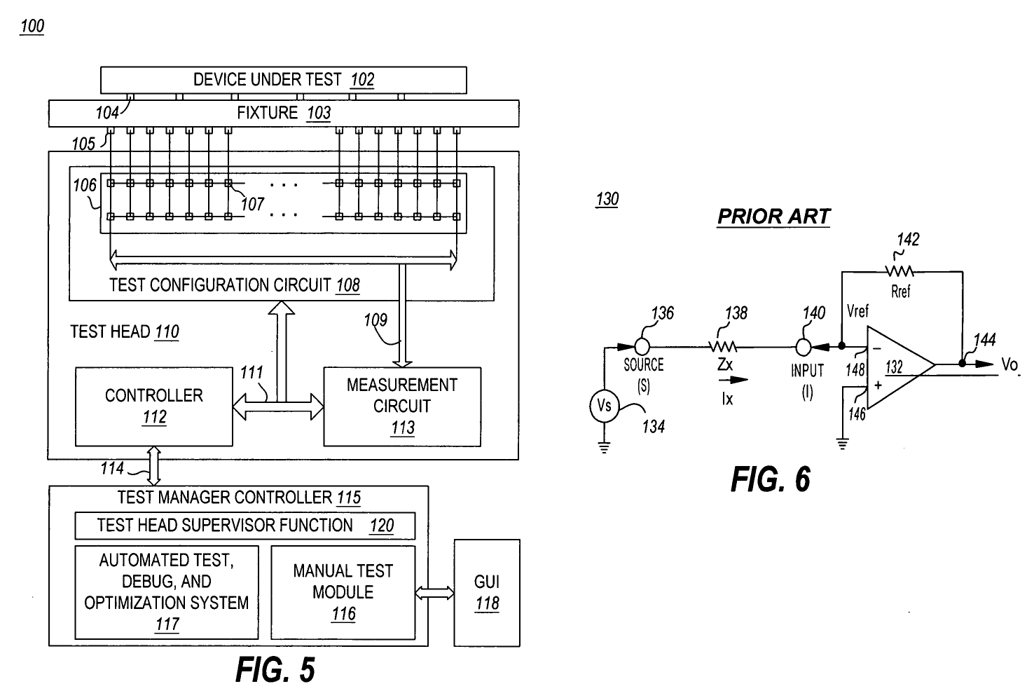

For each test to be executed by the tester under the test plan, the test resources of tester must be configured to perform the test to obtain the test measurements associated with the test. By way of example, FIG. 5 is a schematic block diagram of an example automated in-circuit test system 100 that may be used to test a printed circuit board assembly containing components such as integrated circuits, resistors, capacitors, and other discrete components connected by way of a labyrinth of traces to form a functional circuit. As illustrated, test system 100 includes a test head 110 which supports a fixture 103 on which a printed circuit board (PCB) containing or implementing a device under test (DUT) 102 is mounted by way of a fixture 103. The test head 110 may include a controller 112, a test configuration circuit 108, and a measurement circuit 113. Fixture 103, for example a bed-of-nails fixture, is customized for each PCB layout and includes a plurality of probes 104 that electrically connect to nodes of the device under test 102 when the device under test 102 is properly seated on the fixture 103. Probes 104 are coupled via the fixture 103 to test head interface pins 105.

The test configuration circuit 108 may include a matrix 106 of relays 107 which is programmable via controller 112 over control bus 111 to open and/or close each relay 107 in the matrix 106 to achieve any desired connection between the interface pins 105 of the test head 110 and a set of measurement busses 109. Measurement busses 109 are electrically connected to nodes of the measurement circuit 113. The particular nodes of measurement circuit 113 which are connected to the set of measurement busses 109 may be hardwired within the measurement circuit 113, or alternatively, may be configurable via another programmable matrix (not shown) of relays. Controller 112 receives test setup instructions from a test manager controller 115 to program the matrix 106 (and other relay matrices, if they exist) to achieve a set of desired connection paths between the device under test 102 and measurement circuit 113.

Measurement circuit 130 includes operational amplifier 132 having a positive input terminal 146 coupled to ground and a negative input terminal 148 coupled to an input node I 140. A reference resistor R_{ref} 142 is coupled between output node V_{O} 144 and input node I 140 of operational amplifier 132. A component under test 138 on the DUT 102 characterized by an unknown impedance Z_{X} is coupled between input node I 140 and a source input node S 136. The source input node S 136 is stimulated by a known reference voltage V_{S} that is delivered by a voltage stimulus source 134. Assuming an ideal operational amplifier circuit, the current I_{X} through the unknown impedance Zₓ of the component under test 138 should be equal to the current through reference resistor R_{ref} 142 and a virtual ground should be maintained at negative input terminal 148. As is well-known in the art, in an ideal operational amplifier circuit the theoretical impedance calculation is:
Zₓ=−R_{ref}(V_{S}/V_{O}).

The use of a precision DC voltage stimulus source 34 and a DC detector at output node V_{O} 144 is employed to determine the resistive component of the output voltage when testing resistive analog components such as resistors. The use of a precision AC voltage stimulus source 134 and a phase synchronous detector at output node V_{O} 144 is employed to determine the reactive components of the output voltage when testing reactive analog components such as capacitors and inductors.

Additional measurements, outside the scope of the present invention, are often taken to reduce guard errors and compensate for lead impedances. In order to take a set of measurements, the connection paths from the component under test 138 on the DUT 102 to the measurement circuit 113 are set up by programming the relay matrix 106 to configure the relays 107 to electrically connect the probes 104 of the fixture 103 that are electrically connected to the nodes on the device under test 102 to the measurement circuit 113 via the internal measurement busses 109. In the example measurement circuit 130 of FIG. 4, the internal measurement busses include an S bus and an I bus which are respectively electrically connected to the source node S 136 and input node I 140. Connections of the internal measurement busses 109 from the device under test 102 to the measurement circuit 113 are programmed at the beginning of the test for the component under test 138, during the test setup. After the connections have been made, the actual test measurements of the component under test 138 may be obtained by the measurement circuit 113 after waiting for the inherent delays of the relay connections to be completed. At the conclusion of the test, the relay connections are all initialized to a known state in preparation for the start of the next test.

The measurement circuit 130 described in FIG. 6 is for purposes of example only. FIG. 6 illustrates example hardware connections, in particular, the measurement circuit 113 of FIG. 5, that must be provided by in-circuit test system 100 to perform the in-circuit test on a particular device, in this case as device 138 characterized by an unknown impedance Z_{X}. It will be appreciated, however, that a typical in-circuit test will cover many thousands of devices, including resistors, capacitors, diodes, transistors, inductors, etc.

Turning back to FIG. 5, the test manager controller 115 preferably comprises a test head supervisor function 120, a manual test module 116, and automated test debug and optimization system module 117. The test manager controller 115 preferably communicates with the test head controller 112 over a bus 114. Such communication includes instructions to configure the matrix 106 of relays 107, (and other relay matrices, if they exist) to achieve a set of desired connection paths between the device under test 102 and measurement circuits 113, test data, test instructions, and return test results data generated by the test head 110.

The manual test module 116 may receive manually submitted tests for execution on the test head 110. Manually submitted tests may be submitted, for example, via a graphical user interface 118 executing on a computer system. Manually submitted tests may be formulated by a test engineer on-the-fly or may be pre-formulated and downloaded to the test manager controller 115 at the time the test is to be submitted to the test head 110.

The automated test debug and optimization system 117, discussed in detail hereinafter, generates, debugs and/or optimizes in-circuit tests for the DUT 102 executed by the test head 110.

The test head supervisor function 120 manages the submission of tests received from various sources, for example from both the manual test module 116 and the automated test debug and optimization system module 117, to the test head 110 for execution.

Operation of such an automated test & debug controller 140 is described in greater detail in co-pending U.S. application Ser. No. UNKNOWN, to Loh et al., entitled “Method And Apparatus For Automated Debug And Optimization Of In-Circuit Tests”, and in co-pending U.S. application Ser. No. UNKNOWN, to Loh et al., entitled “A Framework That Maximizes The Usage Of Testhead Resources In In-Circuit Test System”, both of which are hereby incorporated by reference for all that they teach.

In the system 100 of FIG. 5, the automated test debug and optimization system 117 automatically generates tests for the DUT 102 to be executed by the test head 110 based on information contained in a rule-based action knowledge database, for example, 22 in FIG. 4.

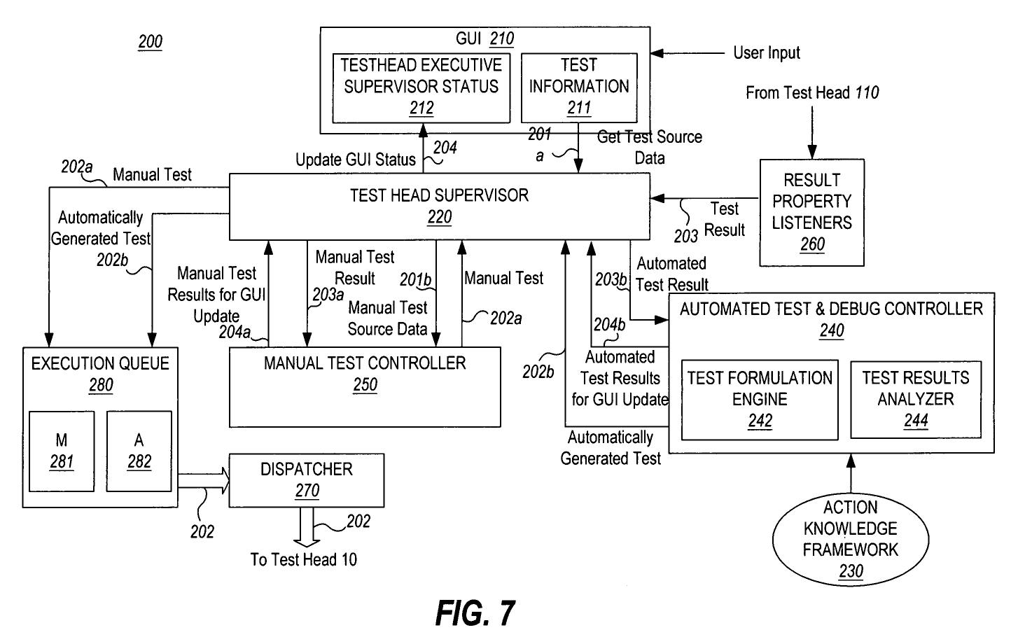

FIG. 7 shows an exemplary embodiment 200 of the software modules of a test system such as test system 100 in FIG. 5 which utilizes a rule-based action knowledge database 230 for the automatic formulation of tests. Generally, the software 200 implements executable software code to perform the functionality for the following modules: a Testhead Execution Supervisor 220, a Manual Test Controller 250, and an Automated Test & Debug Controller 240. It is to be understood that the functionality described for each of the modules may be variously embodied, and that the modules may be combined or the functionality of the modules otherwise distributed.

The Testhead Execution Supervisor 220 is the single point of contact (SPOC) that interfaces between the test head controller engine (112 in FIG. 5) and the Manual Test Controller 250 and Automated Test & Debug Controller 240. All requests to use or access the test head 110 are submitted and synchronized through the Testhead Execution Supervisor 220. The Testhead Execution Supervisor 220 receives tests 202a, 202b to be submitted to the test head 110 from multiple sources, namely the Manual Test Controller 250 and Automated test & debug controller 240, and enters them into one or more execution queues 280 for dispatch to the test head 110. The test head 110 executes only one test at a time. A dispatcher function 270 monitors the status of the test head 110 and if the test head 110 is idle, selects a test 202 from the execution queue(s) 280, sends it to the test head 110 for execution, and removes it from the execution queue 280 once execution of the test 202 by the test head 110 is completed.

A graphical user interface (GUI) 210 collects user input from a user and displays test status and other related information. The GUI 210 includes a test information collection function 211 that collects Test Source Data 201a from the user that is sent through the test head supervisor 220 to the manual test controller 250 (as manual test source data 201b) and used by the manual test controller 250 to formulate a manual test 202a.

The test head supervisor 220 receives manual tests 202a from the manual test controller 250 and causes them to be entered into an execution queue 280, as detailed hereinafter.

When a test 202 is executed on the test head, one or more result property listeners 260 monitor the test head for available test results 203. Test results 203 are forwarded by the result property listeners 260 to the test head supervisor 220 for forwarding on to the appropriate test controller (e.g., the manual test controller 250 if the test result 203a is of a manual test 202a, or the automated test & debug controller 240 if the test result 203b is of an automatically generated test 102b).

The GUI 210 also includes a testhead executive supervisor status function 212 that receives test result status 204 for use in updating the GUI display for presentation to the user.

The automated test & debug controller 240 includes a test formulation engine 242 which generates one or more tests 202b that are ready for execution by the test head 110 during the lifetime of the automated debug controller 240. In automatically generating a test 202b, the test formulation engine 242 accesses a knowledge framework 230 to determine the appropriate actions to take, which may include validation criteria and stability criteria.

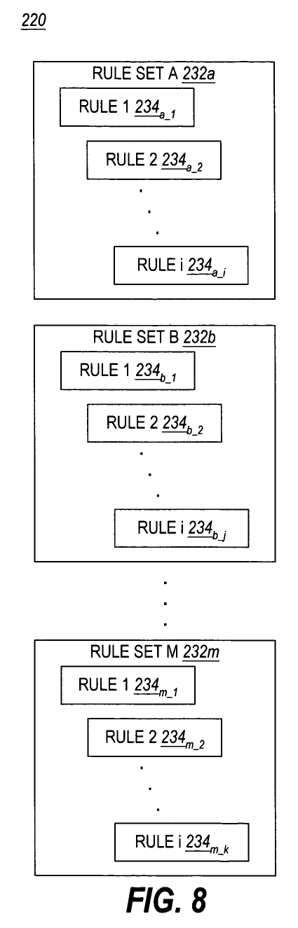

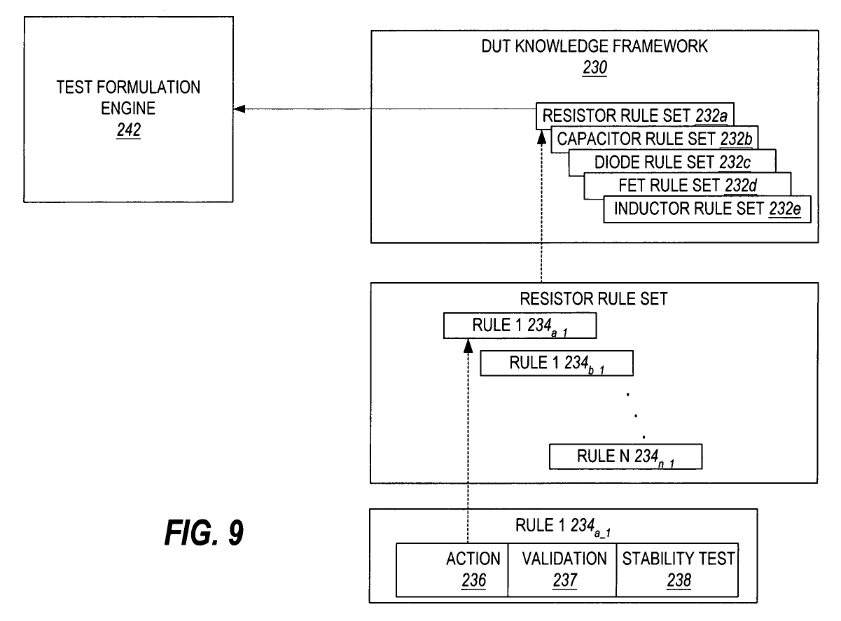

The action knowledge framework 230 contains the test knowledge about the various components to be tested on the DUT 102, which allows the automated debug controller 240 to determine how to formulate and package a given test. A more detailed diagram of a preferred embodiment of the knowledge framework 230 is illustrated in FIG. 8. As shown therein, the knowledge framework 230 includes one or more rule sets 232ₐ, 232_{b}, . . . , 232ₘ. Each rule set 232ₐ, 232_{b}, . . . , 232ₘ, has associated with it one or more rules 234ₐ_{_{—}}₁, 234ₐ_{_{—}}₂, . . . , 234ₐ_{_{—}}ᵢ, 234_{b}_{_{—}}₁, 234_{b}_{_{—}}₂, . . . , 234_{b}_{_{—}}ᵢ, 234ₘ_{_{—}}₁, 234ₘ_{_{—}}₂, . . . , 234ₘ_{_{—}}ₖ. FIG. 7 illustrates the structure 234 of each rule 234ₐ_{_{—}}₁, 234ₐ_{_{—}}₂, . . . , 234ₐ_{_{—}}ᵢ, 234_{b}_{_{—}}₁, 234_{b}_{_{—}}₂, . . . , 234_{b}_{_{—}}ᵢ, 234ₘ_{_{—}}₁, 234ₘ_{_{—}}₂, . . . , 234ₘ_{_{—}}ₖ. As shown in FIG. 7, each rule preferably includes three components, including an action component 236, a validation test component 237, and a stability test component 238 (e.g., a process capability index (CPK)).

The action component 236 represents the debugging/optimization strategy. The action component 236 can implement or point to code such as library functions that are to be executed.

The validation test component 237 comprises or points to a test or algorithm that compares an expected result against the actual results measured by the tester. Typically the validation test component 237 will include many expected parameter values to be verified against the received parameter values in order to verify that the automatically generated test 202b passed.

The stability test component 238 is conducted to verify the robustness of a test. During operation, the stability test component 238 is only performed if the validation test passes. Stability test is conducted by applying the validity test a number of times to gather its statistical value (e.g., the process capability index CPK). The CPK is a measurement that indicates the level of stability of the formulated test derived from the knowledge framework 230.

The knowledge framework 230 includes a rule set for every possible component (e.g., resistor, car, diode, FET, inductor, etc.) to be tested on the DUT 102. The automated debug controller 240 operates at an active rule-set level. Each device/component family can have many rule sets, but at any given time, only one rule set in the knowledge framework 230 can be active. The test formulation engine 242 in the automated debug controller 240 executes only the rules in the active rule set for each device/component family.

The set of rules 234 in each rule set 232 are ordered according to a predetermined priority order. The test formulation engine 242 executes the rules within the rule set according to the predetermined priority order. In particular, the test formulation engine 242 generates a list of parameters/measurements that the test head should obtain based on the action component 230 and validation component 237 of the currently selected rule 234 of the active rule set 232. This list of parameters/measurements represents the merits of the test from which the component being tested can be classified as “good” or “bad”. Other classifications are possible.

Once the test formulation engine 242 automatically generates a test 102b, the automatically generated test 202b is sent to the test head execution supervisor 220 for insertion into the execution queue 280.

The automated debug controller 240 includes a test results analyzer 244. The test results analyzer 244 processes the test results 203b resulting from execution of the test 202b by the test head 110, compares the actual parameters/measurements to those expected as indicated in the test validation component 237 of the rule 234 from which the test 202b was generated.

Operation of the automated test & debug controller 240 is described in greater detail in co-pending U.S. application Ser. No. UNKNOWN, to Loh et al., entitled “Method And Apparatus For Automated Debug And Optimization Of In-Circuit Tests”, which is hereby incorporated by reference for all that it teaches.

A result property listener function 260 monitors status and data coming back from the test head 110 and packages the status and data into test results 203. The test results 203 comprise the test parameters that are actually measured by the test head 110 during execution of the test. The test results 203 are passed back to the test head execution supervisor 220, indicating that test execution on the test head 110 is complete and that the test head 110 resource is freed up for a new job. The test head execution supervisor 220 forwards the test results 203 to the source (i.e., either the manual test controller 250 or the automated test & debug controller 240) from which the test was originated. The dispatcher function 270 monitors the status of the test head 110. When the test head 110 becomes idle due to completion of a test, if there are pending tests waiting for dispatch to the test head 110 present in the dispatch queue 280, removes the next highest priority pending test from the queue 280 and allocates the test head 110 resource to execution of the next test.

In terms of the execution queue 280, the test head supervisor 120 enters testhead-ready tests 202a, 202b in priority order in the execution queue 280. As the test head resource comes available, the dispatcher function 270 removes the highest priority test from the queue 280, and dispatches it to the test head 110 for execution. Preferably, a priority scheme is implemented to ensure that manually submitted tests are executed with higher priority than automatically generated tests.

The above discussion details a test system 100, 200 which executes manual and automatically formulated tests. The test knowledge is preferably stored, controlled, and accessed through a central test information controller and knowledge base such as central test information controller 10 of FIG. 3. In implementation, as shown in FIG. 4, the central test information controller 10 may include a test plan and test resource controller 11 to store and to control access to test plans and tests in the test plan and test resource database 21 of the knowledge base 20. During a production run setup, each tester 30A, 30B, . . . , 30N may communicate with the central test information controller 10 to gain access to the test plan associated with the particular PCB assembly 102 under production and the associated test resource configuration data associated with each of the tests to be executed under the plan. Then, if production is stopped for some reason and one or more intervening jobs for assemblies of different designs are manufactured and tested, since the test plan and test resource configuration data is stored and accessible in a central test plan and test resource database 21, the testers 30A, 30B, . . . , 30N can be quickly set up and reconfigured to manufacture and test PCBs of the previous PCB assembly design once again. More particularly, because the central test information controller 10 is configured with the ability to store Test Plan and Test Source information, and since the central test information controller 10 operates as a single point of control (SPOC) for all test systems 30A, 30B, . . . , 30N, it therefore allows quick and efficient synchronization and version/revision controls of test plan and test resource configurations for multiple tester systems running under the same environment. This production framework therefore allows support of portability, and can be used as the framework for manufacturing production of nearly any type.

The central test information controller 10 stores the test plan and test resources configuration information as data in the test plan and test resources database 21. All testers 30A, 30B, . . . , 30N during a production run of the assembly under test communicate with the central test information controller 10 to get the current test plan for the particular assembly under test. This allows for easy updates and version control of the test plan. For example, if problems with a test are discovered and debugged, the test resource configuration file for that test can be easily updated in the test plan and test resource database 21 via the test plan and test resource controller 11 of the central test information controller 10, and since all tester systems 30A, 30B, . . . , 30C get the test plan and test resource configuration information from the central knowledge base 20 (via the central test information controller 10), all testers can be quickly updated and synchronized with the same updated test plan version with ease and efficiency.

The test system 100, 200 detailed above also utilizes an action knowledge base 230 that contains rule-based actions for automatically formulating tests for execution on the test head 110. In the present invention, this action knowledge base 230 is preferably centralized to maintain a single accessible copy that is accessible by all test systems with valid access privileges. To this end, the action knowledge base 230 is accessed via the central test information controller 10 of FIG. 3, which preferably implements an action knowledge control function 12 which allows access to action knowledge relating to specific components of the DUT 102 stored in an action knowledge database 22, 230 in the knowledge base 20. As in the case with centralization of test plans and test resources, the centralization of the action knowledge base 22, 230 by way of the central test information controller 10 also allows for ease of updates, maintenance, and data synchronization.

A test system such as system 100 of FIG. 4 may include a localization control function 13 which controls access to (i.e., reads and writes) localization information stored in a localization database 23. Localization refers to the adaptation of language, content and design to reflect local cultural sensitivities. Different manufacturing sites may be located in different locales that are characterized by different languages, customs, and graphical presentation configurations. Graphical and textual information presented to users must be presented in a form according to the language, customs, and configurations specific to that site. Generally, operating systems of computerized systems have a configurable locale parameter that may be set to allow display of user interface content in the language and customs of the locale of the system. Each graphical and/or text screen, webpage, or physical documentation for a supported locale that is presented to customers, potential sales prospects, and engineers, must have an associated language translation and custom presentation specific to the supported locale. Supporting even a few different locales can result in a large database support project. Changes and updates to any given document can result in corresponding changes across all locales.

In the preferred embodiment of the present invention, localization data including all information required to present the user interface and documentation to the user in any supported locale, is centrally stored in the knowledge base 20 in the localization database 23. The central test information controller 10 may include a localization database controller 13 that provides access to any information stored in the localization database 23. Because all localization information is stored centrally and accessed through a single point of contact (i.e., the central test information controller 10), only a single copy of each localization file is required, facilitating ease of support to user interface pages and documentation in all locales.

The test system such as system 100 of FIG. 5 may include a statistics or optimization control module (e.g., in the manufacturing floor control system 50 of FIG. 3) that may be configured to automatically collect statistics regarding measurements obtained during execution of certain tests, data concerning the DUT, tester, or test, etc. This data may be communicated to a statistical process control module for analysis. Accordingly, as shown in FIG. 4, the central test information controller 10 may include a measurement data and statistics control function 14 which reads and writes measurement data and/or statistical information to a measurement data and statistics database 24. Again, since all measurement and/or statistics data and/or statistics or optimization control module configuration data is stored centrally and accessed through a single point of contact (i.e., the central test information controller 10), the invention provides centralization of all measurement and/or statistical related information, allowing ease of access of the data across all test systems, thereby facilitating compilation of overall statistical data.

The centralization of the collective system knowledge and control of access to that knowledge serves as both an efficient means of knowledge/configuration support in terms of maintenance and updates. Additionally, the centralization of system knowledge, and the controlled access thereto serves to protect the knowledge from unauthorized copying or viewing. Access to the knowledge base 20 can be restricted generally, or on a tiered structure according to various levels of clearance.

A Product Support Team 60 may be connected to the knowledge base 30 by way of the central test information controller 10 to access and collect testing related information from any of the test systems 30A, 30B, . . . , 30N in the system. This allows ease of providing service and support via internet remote access, and ease of accessing the test systems and statistical information.

Remote users 70 may also be connected to access and collect testing related information from test systems 30A, 30B, . . . , 30N in the system for which the user has authorization. This allows ease of providing service and support via internet remote access, and ease of accessing the test systems and statistical information.

In the preferred embodiment, remote access is provided via the Internet; accordingly, a router 40 is implemented with a virtual private network (VPN) router to provide internet access. A switch is required for intranet access.

Since both the product support team 60 and the end users 70 can access the test systems 30A, 30B, . . . , 30N remotely, the product support team 60 and end users 70 may more easily troubleshoot test system problems.

Since all knowledge is centralized and accessed through the central test information controller 10, software, test plans, test sources, rule-based actions, debug information, troubleshooting information, localization information, documentation, etc., is easily maintained to allow synchronization of all users of the information.

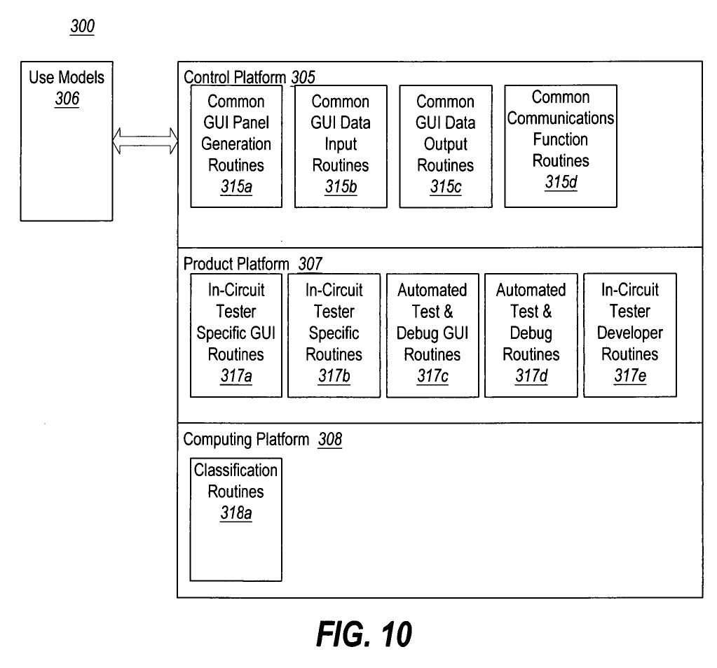

Returning now to the specific aspects of the invention, a product framework such as the product framework described in details above requires a robust and flexible software architecture to support the development and maintenance of the product framework. This software architecture is conceptualized as shown in FIG. 1 by applying the concept of a formal software structure, to the requirements of the product framework. The generalized result is shown in FIG. 2, and the specific result is shown in FIG. 10.

As shown in FIG. 10, software functions including all common interface functions such as generation of GUI panels 315a related to administrative tasks such as environment setup, active panels, display panels common to all products, etc., are implemented within the control platform 305. Communications functions 315b such as used to support a multi-threading environment and interprocess communication, internet communication, and InterLAN communication are implemented in the control platform 304. Preferably, all user interface functions are implemented according to a common set of well-defined use models 316. Referring to the product framework shown in FIGS. 3 and 4, most of the software implementing the central test information controller 10 for retrieval, storage, and access control of knowledge stored in the knowledge base 20 would be implemented in the control platform 305. Many GUI routines for displaying certain panels and displaying or inputting certain information to and from the user stations, remote users 70, the product support team 60, and manufacturing floor control system 50 would also be implemented in the control platform 305. Referring to the in-circuit test systems 100, 200 of FIGS. 5 and 7, respectively, most of the tester operational software would be implemented in the product platform 307. However, certain routines that would be common to all products such as inter-thread communication would be implemented in the control platform 305.

Software functions including all product specific functions such as generation of GUI panels related to product specific tasks 317a such as test system operator panels for specifying test sources, DUT configuration and components, and test result display panels that are specific only to the given product are implemented within the product platform 307. Product-specific internal software such as in-circuit test specific tester routines 317b are also implemented within the product platform 307. Engineering and developer functions such as those used to invoke and interface with the automated test & debug engine 317c, to implement the automated test & debug engine 317d, or to support developer applications 317e are also implemented in the product platform 307.

Software functions including all generic-type algorithm functions such as classification functions 318a that are computation intensive and may be reused by other products are implemented within the computing platform 308.

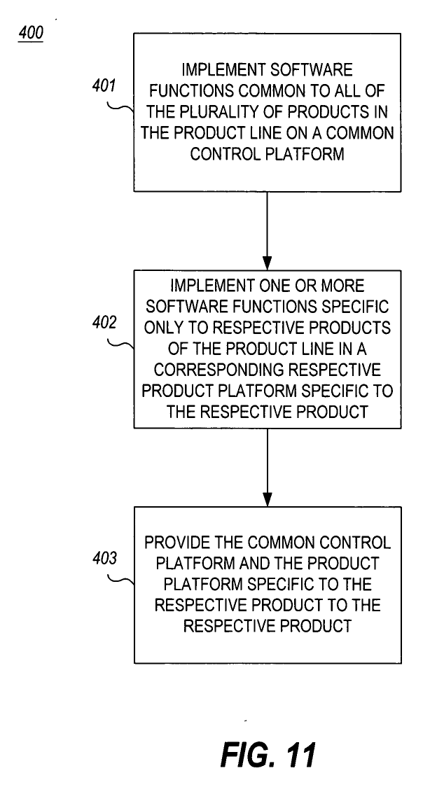

FIG. 11 illustrates an exemplary method 400 for implementing software in a plurality of different products. As shown therein, the method includes the steps of: implementing software functions common to all of the plurality of products in the product line on a common control platform (step 401), implementing one or more software functions specific only to respective products of the product line in a corresponding respective product platform specific to the respective product (step 402), and providing the common control platform and the product platform specific to the respective product to the respective product (step 403). Preferably, the graphical user interface routines common to all products in the product line are implemented in the common control platform to generate a common look and feel across all of the plurality of different products according to a common set of use models.

There are several advantages to using a software framework in accordance with the invention. First, in terms of time-to-market application development (i.e., speed), the architecture of the framework allows for one-time integration effort for hardware devices, one-time development effort for multiple applications, and one-time testing effort for multiple applications. Second, the software framework platform relationships enable segregation of tasks which allows the tasks to be assigned to various different sub-teams within a software team. For example, tasks can be assigned among various software teams such as the Platform Team, the Application Development Team, or the Algorithm Experts Team. These division can be further sub-divided as appropriate. The software framework provides an organization that allows for ownership and accountability by the various teams and sub-teams.

The segregation of software tasks allows sub-teams to be more focused. For example, the platform team can focus on building shared software library device interface, third party software integration, and statistical process control (SPC), while the Application group can focus on application use-model and interface, and the Algorithm Experts can focus on developing the state of the art image processing and testing functions. The 3-tier software architecture therefore allows focus on different aspects of the problem.

Accordingly, the software framework for a product framework provides several benefits, including:
Risk mitigation due to technology shifts—e.g., provides incremental migration (leverage on the three independent layers concept) due to programming platform change;
Full leverage on platform level development—platform knowledge will be retained and reused when shifting from one product to another;
Ease of software outsource management—retain software control and allow parallel software development without having to reveal too much to partners;
Product extensibility—ease of building a hybrid product;
Shorter learning curves and ease of assimilation into the software development environment for new team members due to the modular approach and black box concept.

Those of skill in the art will appreciate that the invented method and apparatus described and illustrated herein may be implemented in software, firmware or hardware, or any suitable combination thereof. Preferably, the method and apparatus are implemented in software, for purposes of low cost and flexibility. Thus, those of skill in the art will appreciate that the method and apparatus of the invention may be implemented by a computer or microprocessor process in which instructions are executed, the instructions being stored for execution on a computer-readable medium and being executed by any suitable instruction processor. Alternative embodiments are contemplated, however, and are within the spirit and scope of the invention.

Although this preferred embodiment of the present invention has been disclosed for illustrative purposes, those skilled in the art will appreciate that various modifications, additions and substitutions are possible, without departing from the scope and spirit of the invention as disclosed in the accompanying claims. For example, although the preferred embodiment has been discussed herein in the context of in-circuit printed circuit board assembly testers, the product framework of the invention may be applied to other manufacturing test systems such as x-ray or optical based technologies, or to testers of other types of products altogether. It is also possible that other benefits or uses of the currently disclosed invention will become apparent over time.

What is claimed is:

1. A software framework for a given product of a product line comprising a plurality of products, comprising:
a control platform comprising identical software functions common to all of the plurality of products in the product line; and
a product platform comprising one or more software functions specific only to the given product of the product line;
wherein all software functions common to all of the plurality of products in the product line are implemented in the control platform and all software functions specific only to the given product of the product line are implemented in the product platform.

2. The software framework of claim 1, wherein the control platform comprises:
graphical user interface routines that present graphical user interface panels common to all of the plurality of products in the product line.

3. The software framework of claim 1, wherein the control platform comprises:
communication routines that provide communication capability common to all of the plurality of products in the product line.

4. The software framework of claim 1, wherein the control platform comprises:
routines that support a multi-threading environment common to all of the plurality of products in the product line.

5. The software framework of claim 1, further comprising:
a computing platform comprising one or more software functions that perform a generic algorithm.

6. A software framework for a plurality of different products, comprising:
a control platform comprising identical software functions common to all of the plurality of products; and
a plurality of respective product platforms one each corresponding to each different product of said plurality of products and each respectively comprising one or more software functions specific only to the respective product;
wherein all software functions common to all of the plurality of products are implemented in the control platform and all software functions specific only to one or more different ones of the plurality of products are implemented in the respective product platforms corresponding to the respective one or more different ones of the plurality of products.

7. The software framework of claim 6, wherein the control platform comprises:
graphical user interface routines that present graphical user interface panels common to all of the plurality of products in the product line.

8. The software framework of claim 6, wherein the control platform comprises:
communication routines that provide communication capability common to all of the plurality of products in the product line.

9. The software framework of claim 6, wherein the control platform comprises:
routines that support a multi-threading environment common to all of the plurality of products in the product line.

10. The software framework of claim 6, further comprising:
a computing platform comprising one or more software functions that perform a generic algorithm.

11. A test system product line, comprising:
a plurality of different test system products, each providing testing functionality and each implementing a plurality of software functions, wherein each different test system product comprises:
a control platform comprising identical software functions common to all of the plurality of different test system products; and
a respective product platform comprising one or more software functions specific only to the respective product.

12. The test system product line of claim 11, wherein at least one of the different test system products further comprises a computing platform comprising one or more software functions that perform a generic algorithm.

13. The test system product line of claim 12, wherein the generic algorithm is implemented in a computing platform of at least one other respective computing platform of at least one other different test system product.

14. A method for implementing software in a plurality of different products, the method comprising the steps of:
implementing software functions common to all of the plurality of products in the product line on a common control platform;
implementing one or more software functions specific only to respective products of the product line in a corresponding respective product platform specific to the respective product; and
providing the common control platform and the product platform specific to the respective product to the respective product.

16. The method of claim 15, further comprising:
implementing graphical user interface routines common to all products in the product line in the common control platform to generate a common look and feel across all of the plurality of different products.

17. The method of claim 15, further comprising:
implementing all user interface routines according to a common set of use models.
